(19) United States
(12) Patent Application Publication
(10) Pub. No.: US 2025/0043608 A1
(43) Pub. Date: Feb. 6, 2025

(54) ASSEMBLY FOR GUIDING A MOVABLE FURNITURE PART

(71) Applicant: Julius Blum Gmbh, Hoechst (AT)

(72) Inventor: Stefan DUER, Schwarzach (AT)

(21) Appl. No.: 18/927,450

(22) Filed: Oct. 25, 2024

Related U.S. Application Data
(63) Continuation of application No. PCT/AT2023/060114, filed on Apr. 5, 2023.

(30) Foreign Application Priority Data
Apr. 29, 2022 (AT) A 50293/2022

(51) Int. Cl. E05D 15/26; E05D 15/30; E05F 1/16

(52) U.S. Cl. CPC E05D 15/264; E05D 15/30; E05F 1/16; E05Y 2900/20

(57) ABSTRACT

An assembly for guiding a movable furniture part includes: a guide system to be fastened to the stationary furniture part; a support on which the movable furniture part is or can be pivotally mounted; and a compensation device for compensating for a tilting moment of the support, or of the movable furniture part positioned thereon, about a tilting axis by a restoring moment. The compensation device includes a cable pull device having a cable; and a cable tensioning device for tensioning the cable. The cable tensioning device includes a limiting element preventing any further tensioning of the cable once a predetermined cable tension is reached.

The present application is a continuation of International Application PCT/AT2023/060114 filed on Apr. 5, 2023. Thus, all of the subject matter of International Application PCT/AT2023/060114 is incorporated herein by reference.

### BACKGROUND OF THE INVENTION

The invention relates to an assembly for guiding a movable furniture part, preferably a furniture door, sliding door or folding sliding door, on a stationary furniture part, preferably a furniture carcass. The invention furthermore relates to a piece of furniture with such an assembly as well as a method for installing such an assembly.

Assemblies as noted above are already known. A disadvantage of such solutions according to the state of the art is that the correct tension of the cable can be checked only with great difficulty or not at all. If the cable is tensioned insufficiently or else too tightly, this has negative effects on the functioning of a cable pull device. In the worst case, the cable pull device does not function properly, which can result in damage to a movable and/or stationary furniture part or a piece of furniture.

The applicant's own, as yet unpublished patent application A 51103/2020 therefore proposes a display device for displaying the cable tension.

A disadvantage of such a solution is that an installer must keep the cable under tension throughout the process of clamping or securing the cable on a support. This makes installation by a single person difficult. Moreover, the cable can cut into the hand of a person who is keeping the cable under tension.

### SUMMARY OF THE INVENTION

The object of the present invention is to avoid the described disadvantages according to the state of the art and to specify an assembly that is improved compared with the state of the art for guiding a movable furniture part, preferably a furniture door, sliding door or folding sliding door, on a stationary furniture part, preferably a furniture carcass, a piece of furniture with at least one such assembly and a method for installing such an assembly.

According to the invention, the cable tensioning device has a limiting device, which can prevent a further tensioning of the at least one cable when a predetermined cable tension is reached.

As a result, there is no need for an installer themselves to make sure that a particular cable tension is complied with. They need only tension the cable, as the limiting device automatically prevents a further tensioning of the cable when there is sufficient or predetermined cable tension.

A piece of furniture according to the invention includes at least one stationary furniture part, at least one movable furniture part, and at least one assembly. Preferably, the piece of furniture has at least one shaft-like cavity in which the at least one movable furniture part can be arranged.

In addition, a method according to the invention for installing an assembly is provided. In this method:
the at least one guide system is fastened to the stationary furniture part in a first method step,
the support is connected to the at least one guide system in a movement-coupled manner in a second method step, and
the cable of the cable pull device is tensioned by the cable tensioning device in a third method step. A further tensioning of the cable is prevented by the limiting device when a predetermined cable tension is reached.

Preferably, the cable tensioning device has an actuating element for actuating the cable tensioning device.

Particularly preferably, an operative connection between the cable tensioning device and the actuating element can be interrupted by the limiting device when a predetermined actuating moment, which preferably correlates with the predetermined cable tension, is reached.

This represents an uncomplicated and reliable possibility of preventing a further tensioning of the cable once a predetermined cable tension has been reached.

Advantageously, the actuating element can be part of the limiting device. This proves advantageous for a compact design of the cable tensioning device.

However, it is also conceivable that the actuating element is formed in another way.

The limiting device can comprise a bearing element, in or on which the actuating element can be or is mounted. This embodiment also makes a more compact formation of the cable tensioning device possible.

The limiting device can preferably comprise a connecting element, through which the bearing element and the actuating element are or can be at least temporarily connected in a movement-coupled manner.

Particularly preferably, the limiting device has an energy storage mechanism, through which a predetermined force is or can be applied to the connecting element, and/or the connecting element is formed as an energy storage mechanism at least in areas. Preferably, the predetermined actuating moment is defined by the energy storage mechanism and/or the connecting element formed as an energy storage mechanism at least in areas.

A movement-coupled connection between bearing element and actuating element can thereby be realized.

Particularly preferably, the connecting element is elastically deformable against the action of the energy storage mechanism and/or of the connecting element formed as an energy storage mechanism at least in areas when the predetermined cable tension is reached. As a result, a movement-coupled connection between the bearing element and the actuating element can be overridden.

The actuating element can thereby be decoupled from the bearing element, such that a further actuation of the actuating element does not result in a further tensioning of the cable.

The cable tensioning device can also have a display device for displaying a cable tension state. It can thereby be checked whether the cable has already been tensioned or not.

Preferably, the display device comprises a display element with an indicator. A display device can thereby be realized in a simple manner.

The cable tensioning device can comprise at least one securing device for securing the at least one cable. This makes an uncomplicated securing of the cable possible.

According to a preferred embodiment, in addition to the at least one cable pull device, at least one pivot lever mechanism is provided. The at least one pivot lever mechanism comprises at least two pivot levers, which are connected to each other in an articulated manner and which are pivotable relative to each other when the support is moved on the stationary furniture part.

With respect to a method according to the invention, the following steps are additionally provided before the third method step:
inserting the cable into the cable tensioning device, and
securing the cable by means of the securing device.

At least one of the at least two pivot levers can also be connected to the at least one guide system and/or to the stationary furniture part in an intermediate step.

A movable furniture part, preferably a sliding door or folding sliding door, can preferably be installed on the support in a further method step.

### BRIEF DESCRIPTION OF THE DRAWINGS

Further details and advantages of the invention are explained in more detail below with the aid of the description with reference to the drawings, in which:

FIG. 1 is a perspective view of a piece of furniture with an assembly,

FIG. 2a is a perspective view of a part of a piece of furniture with an assembly,

FIG. 2b shows the detail A of FIG. 2a,

FIG. 3 is a partially exploded representation of a cable tensioning device,

FIG. 4a is an exploded representation of a limiting device and of a tensioning unit,

FIG. 4b is a perspective view of a limiting device,

FIG. 4c is a perspective view of a bearing element and of an actuating element,

FIG. 4d is a perspective view of a connecting element,

FIG. 4e is a sectional representation of a limiting device, and

FIGS. 5a-c a cable tensioning device in a front view during a step of a method according to the invention.

### DETAILED DESCRIPTION OF THE INVENTION

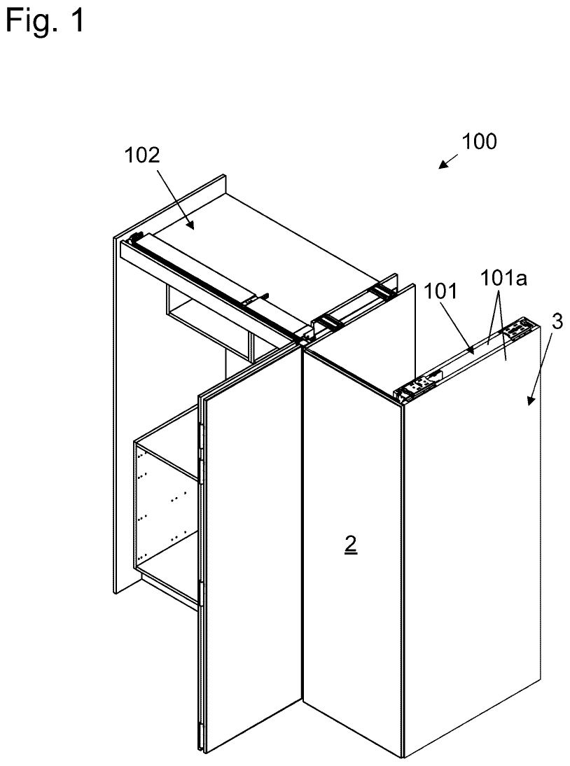

A piece of furniture 100 which can comprise different component parts, for example several drawers inside the piece of furniture 100, is represented in a perspective view in FIG. 1. The stationary furniture part 3 is formed by a furniture carcass.

The piece of furniture 100 has a cavity 101, which is formed of two furniture walls 101a spaced apart from each other. A movable furniture part 2 in the form of a furniture door is retractable into the cavity 101. If the furniture door is closed, it conceals the interior of the piece of furniture 100.

A further part of the piece of furniture 102, for example a cabinet, is then arranged on the piece of furniture 100. If the furniture door is in a closed position and the further part of the piece of furniture 102 is also closed, the furniture door and the further part of the piece of furniture 102 form a continuous furniture front.

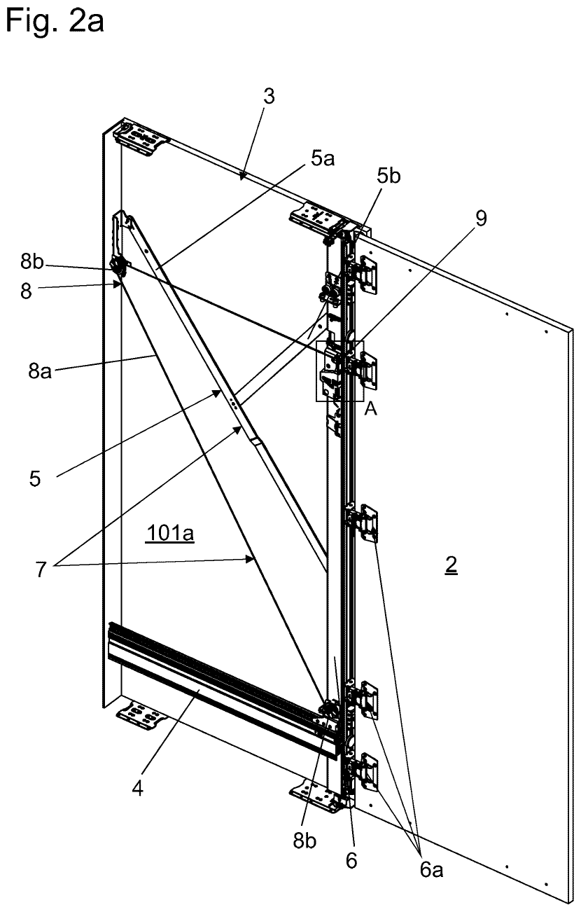

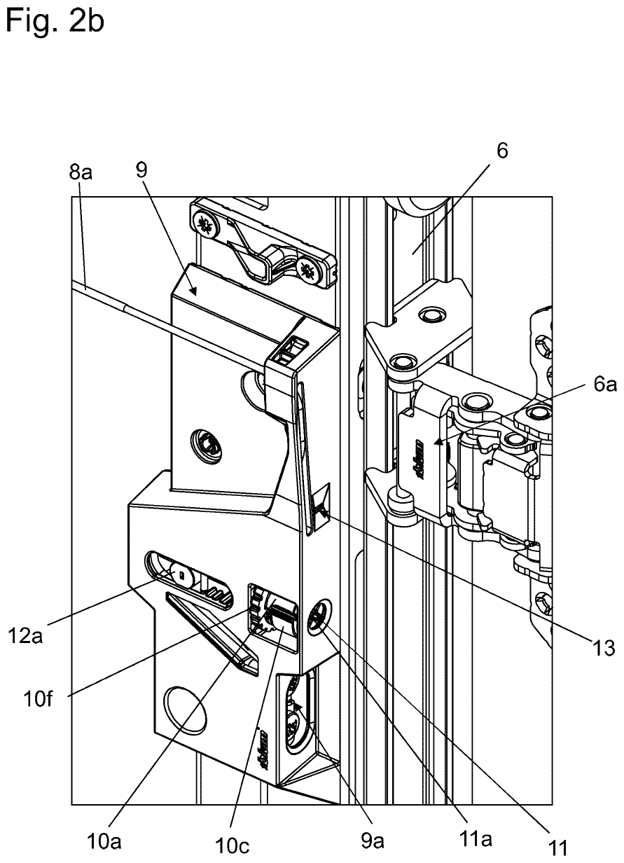

FIG. 2a shows a part of a piece of furniture 100 with an assembly 1 in a perspective view. For better understanding, the second furniture wall 101a of the cavity 101 is not represented. A guide system 4 and a furniture wall 3 can be seen. A support 6 is also visible. However, a further guide system or several further guide systems can also be provided here.

A movable furniture part 3 is pivotably mounted on the support 6 via hinges 6a.

A compensation device 7 consists of a cable pull device 8 and a pivot lever mechanism 5. The pivot lever mechanism 5 consists of a first 5a and a second 5b pivot lever. The first pivot lever 5a is arranged on the stationary furniture part 3 and displaceably on the support 6. The second pivot lever 5b is arranged on the support 6 and in the middle of the first pivot lever 5a.

The cable pull device 8 comprises a cable 8a and deflection rollers 8b, which are arranged on the furniture wall 101a and/or on the guide system 4. The cable tensioning device 9 is arranged on the support 6.

FIG. 2b shows the detail A of FIG. 2a. The cable tensioning device 9 can be seen. The cable tensioning device 9 has a housing 9c, through which the cable 8a is fed.

A part of the securing device 9a, by means of which the cable 8a can be fixed on the cable tensioning device 9 and therefore on the support 6, is visible in the lower area. A limiting device 10 is likewise only partially visible.

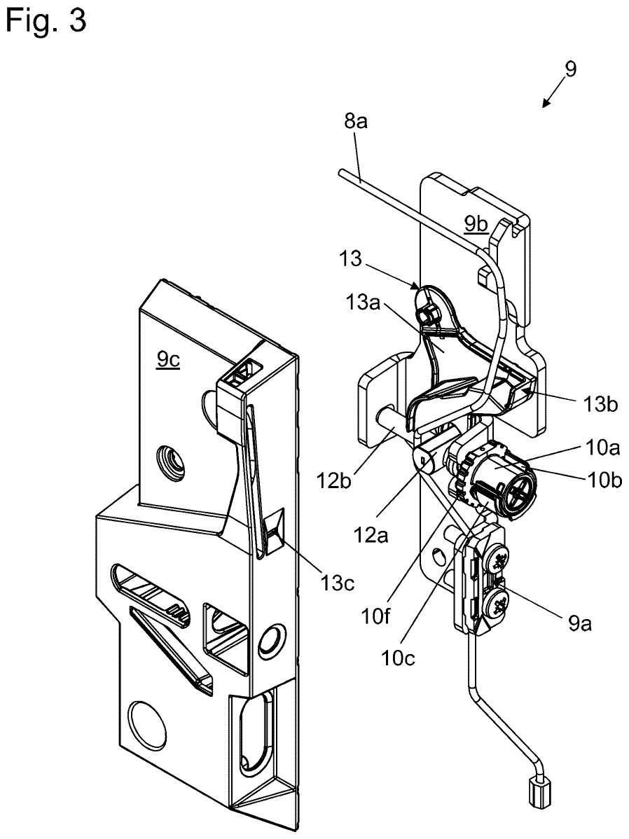

FIG. 3 shows a partially exploded representation of a cable tensioning device 9. A base body 9b can be seen. A securing device 9a, which is at least partially formed by the base body 9b, is arranged on the base body 9b.

The securing device 9a comprises two clamping jaws, which can be screwed to each other via two screws. The cable can be clamped and thus secured between the clamping jaws. However, other formations of securing devices are also conceivable, for example spring-loaded clamping elements or toothed clamping elements.

A tensioning unit 12 comprises a tensioning element 12b and a contact element 12a. The tensioning element 12b has a movement thread, wherein the clamping element 12a with a corresponding thread is arranged on this movement thread.

The tensioning element 12b is rotatably, but non-displaceably, mounted on the base body 9c. Rotating the tensioning element 12b therefore results in a movement of the clamping element 12a in the axial direction of the tensioning element 12b.

The limiting device 10 is connected to the tensioning element 12b in a movement-coupled manner.

A display device 13 comprising a display element 13a with an indicator 13b and an inspection window 13c can also be seen. The display element 13a is pivotably mounted on the base body 9b.

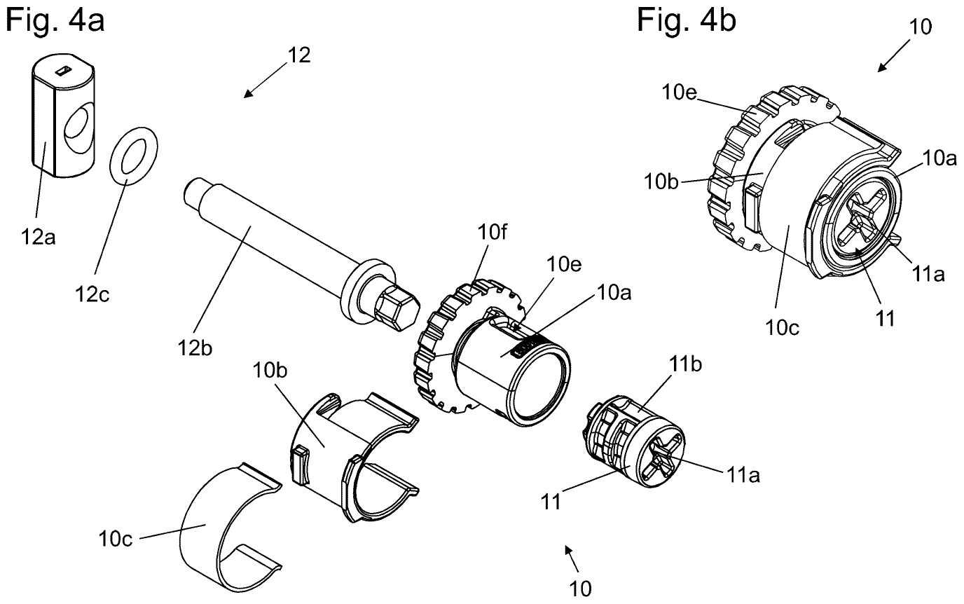

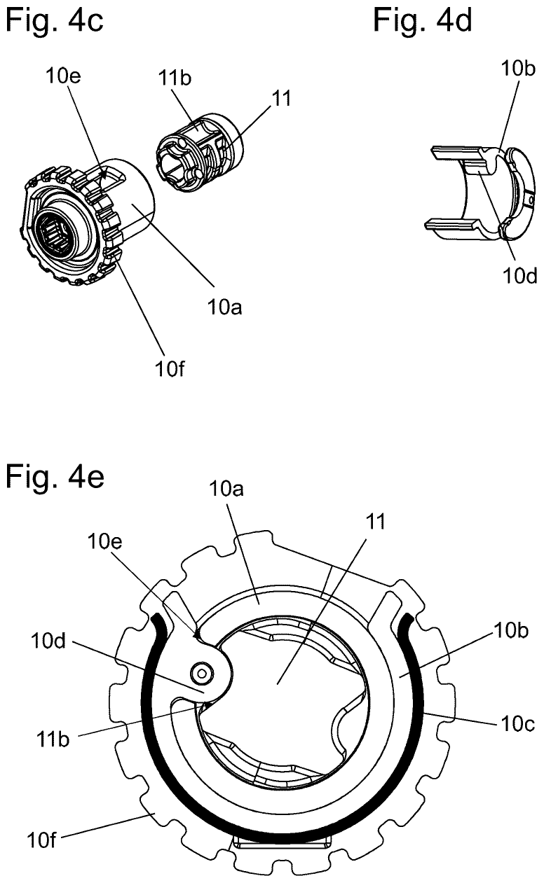

The functioning of the limiting device is explained in more detail below with reference to FIGS. 4a to 4e. FIG. 4a shows an exploded representation of a limiting device 10 and of a tensioning unit 12, FIG. 4b shows a perspective view of a limiting device 10, FIG. 4c shows a perspective view of a bearing element 10a and of an actuating element 11, FIG. 4d shows a perspective view of a connecting element 10b and FIG. 4e shows a sectional representation of a limiting device 10.

The bearing element 10a is formed substantially rotationally symmetrical. A movement-coupled connection between bearing element 10a and tensioning element 12b can be produced via a hexagonal stub shaft of the tensioning element 12b and a corresponding receiver in the bearing element 10a (see FIG. 4c). Of course, any other suitable type of connection is conceivable here.

The actuating element 11 is mounted in the bearing element 10a. Without a connecting element 10b, the actuating element 11 can rotate freely in the bearing element.

The connecting element 10b is formed substantially partially circular and has a connecting stud 10d. This connecting stud passes through the opening 10e in the bearing element 10a and rests against a control contour 11b of the actuating element 11.

A defined force is applied to the connecting element 10b by a likewise substantially partially circular energy storage mechanism 10c in the form of a spring.

There is thus an at least temporary movement-coupled connection between bearing element 10a and actuating element 11.

If the actuating element 11 is actuated, in this embodiment rotated, the bearing element 1a and consequently the tensioning element 12b also rotates, which in turn results in a movement of the contact element 12a.

In the present embodiment, the actuating element 11 has a screw drive 11a, whereby the actuating element 11 can be actuated via a screwdriver.

If the contact element 12a encounters resistance, for example because the cable is or has been tensioned, a higher actuating moment, in this case turning moment, on the actuating element 11 is necessary in order to move the contact element 12a further.

In the case of a sufficiently high actuating moment, the actuating element 11 shifts the connecting stud 10d upward over the control contour 11b against the action of the energy storage mechanism 10c. The actuating element 11 starts to rotate inside the bearing element 10a.

If the actuating moment is further increased, the actuating element 11 continues to rotate until the connecting stud 10d has moved out of the depression of the control profile 11b. There is now no longer a movement coupling between bearing element 10a and actuating element 11. A further rotation, thus actuation, of the actuating element 11 does not result in a further rotation of the bearing element 10a nor therefore a movement of the contact element 12a nor consequently a further tensioning of the cable 8a.

The force with which the energy storage mechanism 10c counters a movement of the connecting stud 10d out of the opening 10e can be chosen such that the connecting stud 10d runs over the raised area 11c precisely when the predetermined or desired cable tension is reached.

It is thereby possible that a further tensioning of the at least one cable 8a can be prevented by the limiting device 10 when a predetermined cable tension is reached.

A resilient element 12c, which can be formed e.g. as an O-ring, can be arranged between the contact element 12a and the tensioning element 12b. The advantage of this element 12c is that a jamming of the contact element 12a and the tensioning element 12b in the case of incorrect actuation of the tensioning element 12b can be prevented.

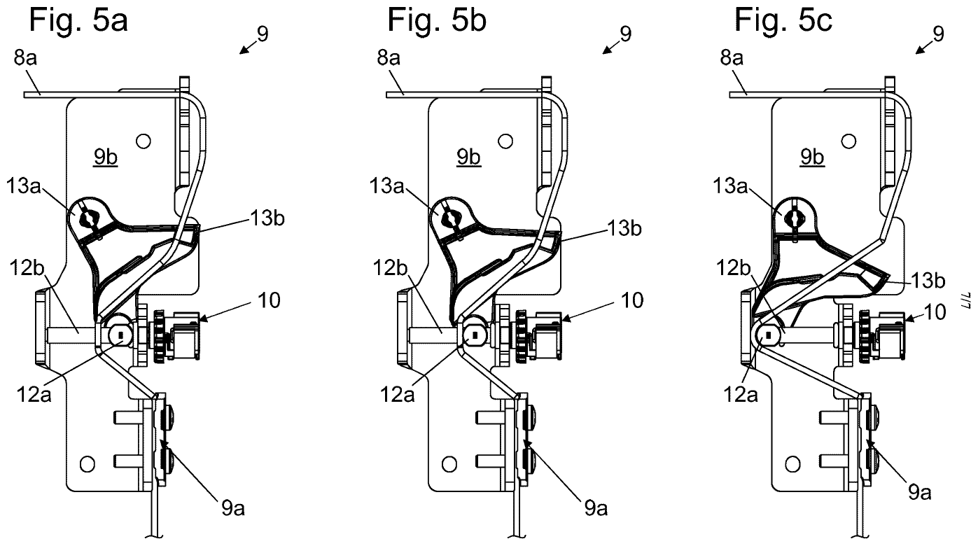

FIGS. 5a to 5c show a cable tensioning device 9 in a front view during a step of a method according to the invention.

In FIG. 5a, it can be seen that the cable 8a has already been fed through the cable tensioning device 9 and fixed on the base body 9b by means of the securing device 9a.

The cable 8a is not yet tensioned, which is indicated by the fact that the contact element 12a is not yet in contact with the cable 8a.

The cable is also fed through the display element 13a, wherein the indicator 13b is visible in the inspection window 13c. The display element 13a can for example be pretensioned via a spring, with the result that the indicator 13b is visible in the inspection window 13c in the untensioned state of the cable.

In FIG. 5b, the actuating element 5b has been actuated and the contact element 12a has been brought into contact with the cable 8a. It is also conceivable that this has been effected via a direct rotation of the bearing element 10a by means of the actuating portion 10f.

With reference to the display element 13a it can be seen that the cable 8a has already been tensioned a little. The display element 13b has namely been pushed down by the cable 8a.

In FIG. 5b, the cable 8a is fully tensioned. The display element 13a has been completely pushed down and the indicator 13b is thus no longer visible in the inspection window 13c.

The maximum displacement of the cable tensioning device 9 is represented in this figure. As a rule, the actual position of the contact element 12a will be between the positions represented in FIGS. 5b and 5c.

On the one hand, the actual position of the contact element 12a when the predetermined cable tension is reached depends on the predetermined cable tension itself. On the other hand, it is also decisively influenced by the point on the cable 8a at which an installer fixes the cable 8a in the securing device 9a.

It is conceivable that corresponding markings, which mark an allowed clamping area, are provided on the cable 8a.

1. An assembly for guiding a movable furniture part, preferably a furniture door, sliding door or folding sliding door, on a stationary furniture part, preferably a furniture carcass, the assembly comprising:
at least one guide system to be fastened to the stationary furniture part,
a support, on which the movable furniture part is or can be pivotably mounted,
a compensation device for compensating for a tilting moment of the support or of the movable furniture part arranged thereon about a tilt axis using a restoring moment, wherein the compensation device comprises at least one cable pull device with at least one cable, and
a cable tensioning device for tensioning the at least one cable,
wherein the cable tensioning device has a limiting device, which can prevent a further tensioning of the at least one cable when a predetermined cable tension is reached.

2. The assembly according to claim 1, wherein the cable tensioning device has an actuating element for actuating the cable tensioning device.

3. The assembly according to claim 2, wherein an operative connection between the cable tensioning device and the actuating element can be interrupted by the limiting device when a predetermined actuating moment, which preferably correlates with the predetermined cable tension, is reached.

4. The assembly according to claim 2, wherein the actuating element is part of the limiting device.

5. The assembly according to claim 2, wherein the limiting device comprises a bearing element, in or on which the actuating element can be or is mounted.

6. The assembly according to claim 5, wherein the limiting device comprises a connecting element, through which the bearing element and the actuating element are or can be at least temporarily connected in a movement-coupled manner.

7. The assembly according to claim 6, wherein the limiting device has an energy storage mechanism, through which a predetermined force is or can be applied to the connecting element, and/or wherein the connecting element is formed as an energy storage mechanism at least in areas, preferably wherein the predetermined actuating moment is defined by the energy storage mechanism and/or the connecting element formed as an energy storage mechanism at least in areas.

8. The assembly according to claim 6, wherein the connecting element is formed elastically deformable at least in areas.

9. The assembly according to claim 7, wherein the connecting element is elastically deformable against the action of the energy storage mechanism and/or of the connecting element formed as an energy storage mechanism at least in areas when the predetermined cable tension is reached, as a result of which a movement-coupled connection between the bearing element and the actuating element can be overridden.

10. The assembly according to claim 2, wherein the actuating element has a screw drive.

11. The assembly according to claim 2, wherein the actuating element is formed substantially rotationally symmetrical.

12. The assembly according to claim 5, wherein the bearing element is formed substantially rotationally symmetrical.

13. The assembly according to claim 6, wherein the connecting element and/or the energy storage mechanism is/are formed partially circular.

14. The assembly according to claim 6, wherein the connecting element has a connecting stud, wherein the connecting stud passes through the bearing element through an opening in the bearing element.

15. The assembly according to claim 14, wherein the connecting stud rests against a control contour of the actuating element.

16. The assembly according to claim 1, wherein the cable tensioning device has a tensioning unit comprising a contact element for contacting the at least one cable and a tensioning element for tensioning the at least one cable via the contact element.

17. The assembly according to claim 16, wherein the contact element is mounted on the tensioning element via a movement thread, and/or wherein at least one resilient element, which is preferably formed as an O-ring, is arranged between the contact element and the tensioning element.

18. The assembly according to claim 17, wherein the tensioning element is or can be connected to the bearing element in a movement-coupled manner.

19. The assembly according to claim 5, wherein the bearing element has an actuating portion for pretensioning the cable tensioning device.

20. The assembly according to claim 1, wherein the cable tensioning device has a display device for displaying a cable tension state.

21. The assembly according to claim 20, wherein the display device comprises a display element with an indicator.

22. The assembly according to claim 1, wherein the cable tensioning device comprises at least one securing device for securing the at least one cable.

23. The assembly according to claim 1, wherein, in addition to the at least one cable pull device, at least one pivot lever mechanism is provided, wherein the at least one pivot lever mechanism comprises at least two pivot levers, which are connected to each other in an articulated manner and which are pivotable relative to each other when the support is moved on the stationary furniture part.

24. A piece of furniture comprising:
a stationary furniture part,
a movable furniture part, and
the assembly according to claim 1,
preferably wherein the piece of furniture has at least one shaft-like cavity in which the at least one movable furniture part can be arranged.

25. A method for installing the assembly according to claim 1, wherein
the at least one guide system is fastened to the stationary furniture part in a first method step,
the support is connected to the at least one guide system in a movement-coupled manner in a second method step, and
the cable of the cable pull device is tensioned by means of the cable tensioning device in a third method step, wherein a further tensioning of the cable is prevented by the limiting device when a predetermined cable tension is reached.

26. The method according to claim 25, further comprising before the third method step:
inserting the cable into the cable tensioning device, and
securing the cable by means of the securing device.

27. The method according to claim 25, wherein at least one of the at least two pivot levers is connected to the at least one guide system and/or to the stationary furniture part in an intermediate step.

28. The method according to claim 25, wherein a movable furniture part, preferably a furniture door, sliding door or folding sliding door, is installed on the support in a further method step.
